(19) United States
(12) Patent Application Publication
(10) Pub. No.: US 2011/0144288 A1
(43) Pub. Date: Jun. 16, 2011

(54) Production of Silylated Polyurethane and/or Polyurea

(76) Inventors: Simone Klapdohr, Rosenheim (DE); Burkhard Walther, Garching (DE); Helmut Mack, Traunstein (DE); Zhizhong Cai, Trostberg (DE); Laurent Marc, Hericy (FR); Jochen Mezger, Garching an der Alz (DE); Tobias Austermann, Munster (DE); Silke Flakus, Ebersberg (DE)

(21) Appl. No.: 13/054,811

(22) PCT Filed: Jun. 16, 2009
(86) PCT No.: PCT/EP2009/057448

§ 371 Date: Feb. 28, 2011

(30) Foreign Application Priority Data
Aug. 8, 2008 (EP) 08162049.4

(51) Int. Cl. C08G 18/00; B05D 3/02; B05D 3/00; B05D 1/36; B05D 7/24

(52) U.S. Cl. 525/460; 427/387; 427/374.1; 427/8

(57) ABSTRACT

The invention relates to a process for the preparation of silylated polyurethanes and/or polyureas, comprising the steps: a) application of a component β) containing isocyanate and of a component α) containing polyol and/or polyamine to at least one surface of body A, which surface rotates about an axis of rotation and has a temperature between 60 and 400° C., and b) reaction of the reaction product of β) isocyanate and α) polyol and/or polyamine with a silylating agent.

The present invention relates to a process for the preparation of silylated polyurethanes and/or polyureas, and silylated polyurethanes and/or polyureas which can be prepared by this process.

Silylated polyurethanes have usually been produced to date on the industrial scale in batchwise processes in which the generally known disadvantages of the batchwise procedure, such as the long loading and unloading times, poor heat transmission and mass transfer, varying quality of the products, etc., are manifest. In the continuous procedure for the preparation of silylated polyurethanes which is desired with regard to process intensification, these disadvantages should at least be present to a less pronounced extent. However, there appears to date still to be no corresponding satisfactory concept of process intensification for the industrial production of silylated polyurethanes.

As a continuous process for the preparation of silylated polyurethanes, WO 2007/037824 A2 proposes a process in which a continuous stream of polyol and isocyanate is reacted in a first reaction zone of a reactor to give polyurethane. In a second reaction zone, a silylating agent is fed in continuously and reacted continuously with the polyurethane so that temperature and reaction time are sufficient to form a silylated polyurethane, the reactants being fed linearly through the reaction zones. The product is then removed continuously from the reactor. Reactors proposed are in particular tubular reactors with static mixers.

A substantial disadvantage of the process is the lack of self-cleaning of the reactors proposed. Thus, product deposits form in dead zones in the process and lead to constriction and finally to closing of the free flow cross section of the tubular reactor and limit the stability and continuity of the preparation process.

It is an object of the invention to provide a procedurally flexible and economical process for the preparation of silylated polyurethanes which ensures consistently good product quality.

This object is achieved by a process for the preferably continuous preparation of silylated polyurethanes and/or polyureas, comprising the steps:
a) application of a component β) containing isocyanate and of a component α) containing polyol and/or polyamine to at least one surface of body A, which surface rotates about an axis of rotation and has a temperature between 60 and 400° C.,
b) reaction of the reaction product of β) isocyanate and α) polyol and/or polyamine with a silylating agent.

The body A rotating about an axis of rotation permits process management in which the combination of particularly short residence times and high reaction temperatures is realized. Thus, the process according to the invention ensures that the components β) and α) can be heated abruptly and strongly and can be reacted correspondingly rapidly.

The preferably continuous application of β) isocyanate and α) polyol and/or polyamine to at least one surface of body A, which surface rotates about an axis of rotation, offers a possibility of flexible and simple process optimization. The scale-up which is often problematic in process engineering is particularly easy owing to the simplicity and usually relatively small size of the reactor comprising the body A. Furthermore, it should be mentioned that both the capital costs and the maintenance costs (cleaning, etc.) of said reactor are very low. Moreover, the quality of the product obtained can easily be varied in a targeted manner by changing the process parameters (residence time, temperature, metering of the components β), α) and optionally the silylating agent).

In a preferred embodiment of the invention, the silylating agent is preferably applied continuously to a rotating surface of the body A, the application being carried out in a surface region on which the degree of reaction of β) isocyanate with α) polyol and/or polyamine is at least 75 mol %, if appropriate based on the component used in less than the stoichiometric amount.

In a further preferred embodiment of the invention, the reaction product of β) isocyanate and α) polyol and/or polyamine is reacted with a silylating agent in a preferably continuous mixing apparatus after leaving the body A. The apparatuses known to the person skilled in the art are suitable here. In particular, it is envisaged that it is a static mixer, an extruder, a cascade of continuous stirred tanks, a spinning-disc reactor and a T-mixer. With the use of the mixing apparatus, it is preferable if the temperature of the reaction mixture containing polyurethanes and silylating agent is set at between 5 and 120° C., particularly preferably between 20 and 80° C.

The reaction mixture is preferably cooled after leaving the surface of the body A. A quench device can be used for cooling the product. This is preferably present in the form of one or more cooling walls which permit rapid cooling of the reaction mixture. The cooling is preferably effected within five seconds at the most, particularly preferably within only one second. The cooling walls, which are frequently cylindrical or conical, have either a smooth or a rough surface, the temperature of which is typically between −50° C. and 80° C. The rapid cooling of the reaction composition effected by means of the quench device is preferably at least 50° C., particularly preferably at least 100° C.

The rotating body A may be disc-shaped, vase-shaped, annular or conical, a horizontal rotating disc or a rotating disc deviating from the horizontal by up to 45° C. being regarded as preferred. Usually, the body A has a diameter of 0.10 m to 3.0 m, preferably 0.20 m to 2.0 m and particularly preferably 0.20 m to 1.0 m. The surface may be smooth, wavy and/or concave or convex or may have, for example, ripple-like or spiral mouldings which have an effect on the mixing and the residence time of the reaction mixture. The body A can preferably be produced from metal, glass, plastic or a ceramic. Expediently, the body A is installed in a container which is resistant under the conditions of the process according to the invention.

The rotational speed of the body A and the metering rate of the components are variable. Usually, the speed of revolution in revolutions per minute is 1 to 20 000, preferably 100 to 5000 and particularly preferably 200 to 2000. The volume of the reaction mixture which is present on the rotating body A per unit area of the surface is typically 0.03 to 40 ml/dm², preferably 0.1 to 10 ml/dm², particularly preferably 1.0 to 5.0 ml/dm². It is to be regarded as preferred that the components β), α) and optionally the silylating agent are present on the surface of the rotating body A in the form of a film which has an average thickness between 0.1 μm and 6.0 mm, preferably between 60 and 1000 μm, particularly preferably between 100 and 500 μm.

The average residence time (frequency average of the residence spectrum) of the components is dependent, inter alia, on the size of the surface, on the type of compounds, on the temperature of the surface and on the speed of revolution of the rotating body A and is usually between 0.01 and 60 seconds, particularly preferably between 0.1 and 10 seconds, in particular 1 to 7 seconds, and is therefore to be regarded as being extremely short. This ensures that the extent of possible decomposition reactions and the formation of undesired products are greatly reduced and hence the quality of the substrates is preserved.

The temperature of the rotating body A, in particular of the surface facing the applied components, can be varied within wide ranges and depends both on the substrates used and on the residence time on the body A. The temperature of the heated surface is preferably between 70 and 240° C., in particular between 150 and 230° C. The components applied to the body A and/or the rotating body A can be heated, for example electrically, with a heat-transfer liquid, with steam, with a laser, with microwave radiation or ultrasound or by means of infrared radiation.

In a further embodiment of the invention, it is envisaged that the surface of the body A extends to further rotating bodies so that, prior to cooling, the reaction mixture passes from the hot surface of the rotating body A to the hot surface of at least one further rotating body having a hot surface. The further rotating bodies expediently correspond in nature to the body A. Typically, body A then “feeds” the further bodies with the reaction mixture. The reaction mixture leaves this at least one further body and is then cooled.

A preferred embodiment of the invention envisages that the rotating body A is present as a rotating disc to which the starting components α) and β) are applied individually and/or as a mixture, preferably continuously with the aid of a metering system in the central region of the surface. In order to cool the reaction mixture, a quench device in the form of a cooling wall surrounding the rotating disc is present, onto which quench device the reaction composition strikes after leaving the hot surface, the silylating agent optionally also being applied beforehand to the rotating disc. The central region of the surface of the rotating disc is to be understood as meaning in particular a distance of 35% of the radius starting from the centred axis of rotation. It is to be regarded as particularly preferred if the rotating disc is a spinning-disc reactor, such reactors being described in more detail, for example in the documents WO00/48728, WO00/48729, WO00/48730, WO00/48731 and WO00/48732.

Throughput control of the preferably continuous process can be via the metering of the components β), α) and the silylating agent. Throughput control can be carried out by means of electronically actuable or manually operable outlet valves or closed loop control valves. In this case, the pumps, pressure lines or suction lines must transport not only against the viscosity of the starting materials but also against a certain constant, freely adjustable pressure of the installed closed loop control valve. This method of flow regulation is particularly preferred.

The metering system described makes it possible for the components β), α) and optionally the silylating agent to be added in a very variable manner at different positions of the rotating body A. A portion or the total amount of components β) and α) can, however, also be premixed and only thereafter applied by means of the metering system to the surface of the rotating body A.

Usually, the process parameters are adjusted so that the degree of reaction of β) isocyanate with α) polyol and/or polyamine is preferably at least 95 mol %, particularly preferably at least 98 mol %, if appropriate based on the component used in less than the stoichiometric amount. In this context, in particular the temperature, the residence time, the layer thickness of the applied film, the dose and the type and concentration of the components β) and α) used may be mentioned as process parameters. The reaction product is then brought into contact with the silylating agent directly on the rotating body A or first cooled and then introduced with the silylating agent into a preferably continuous mixing apparatus, depending on the process variant. In both variants, the silylating agent may preferably be introduced continuously by means of a metering system.

The reaction and hence also the product quality can be optionally controlled by an on-line measurement. It has proved to be expedient here if the amount of silylating agent, which is preferably introduced continuously, is controlled via a preferably continuous measurement by means of which the content of the groups reactive toward the silylating agent in the reaction mixture containing polyurethanes/polyureas is determined. Suitable methods of measurement are all those which can detect the conversion of the reaction in sufficiently short times. These are, for example, spectroscopic methods, such as near-infrared spectroscopy, FT-IR spectroscopy, Raman and FT-Raman spectroscopy.

In a preferred embodiment of the invention, the molar ratio of isocyanate groups of the component β) used to the sum of the amino groups and hydroxyl groups of the component α) used is from 0.1 to 10, preferably from 0.5 to 1.8.

An embodiment of the present invention envisages that the reaction of the component α) with component β) is carried out with an excess of NCO groups. In this embodiment, alkoxysilanes containing amino groups are preferably used as the silylating agent.

A further embodiment of the present invention envisages that the reaction of the component α) with component β) is carried out with an excess of OH groups. In this embodiment, alkoxysilanes containing isocyanate groups are preferably used as the silylating agent.

In a preferred embodiment of the invention, the molar ratio of silylating agent to those terminal groups in the reaction mixture containing polyurethanes/polyureas which are reactive towards the silylating agent is from 0.1 to 3, preferably from 0.8 to 1.2.

The process according to the invention is preferably carried out at atmospheric pressure and in an atmosphere of dry inert gas but, alternatively for expulsion of residual isocyanate in gaseous form, the process can be operated in vacuo or, in order to increase the temperature, under pressure.

Plasticizers, lubricants, molecular chain regulators, flameproofing agents, inorganic/organic fillers, dyes, pigments and stabilizers (with regard to hydrolysis, light and thermal degradation), chain extenders, solvents and catalysts are often also used as further constituents of the components β), α) and of the silylating agent in the process according to the invention.

In a preferred embodiment, no catalyst suitable for the preparation of polyurethanes is used in the process according to the invention. This process variant is used in particular at reaction temperatures above 70° C., in particular above 150° C., and with the use of reactive starting components. The absence of the catalyst in the polymeric product of the process is to be regarded as a substantial qualitative advantage.

One embodiment envisages that a catalyst which is suitable for the preparation of polyurethanes and is preferably present as a constituent of the starting reaction components is used. Suitable catalysts are the customary catalysts of polyurethane chemistry which are known per se, such as acids, e.g. para-toluenesulphonic acid, or tertiary amines, such as, for example, triethylamine, triethylenediamine (DABCO) or those which have atoms such as, for example, Sn, Mn, Fe, Co, Cd, Ni, Cu, Zn, Zr, Ti, Hf, Al, Th, Ce, Bi, Hg, N, P. The molar catalyst/isocyanate ratio is dependent on the type of isocyanate and the type of catalyst and is usually between from 0 to 0.1, preferably from 0 to 0.03.

Solvents may also be used as constituents of the components β), α) and of the silylating agent. These solvents can escape during the reaction through boiling or can remain in the mixture. Suitable solvents are, for example, ethyl acetate, butyl acetate, 1-methoxyprop-2-yl acetate, 3-methoxy-n-butyl acetate, 2-butanone, 4-methyl-2-pentanone, cyclohexanone, toluene, xylene, chlorobenzene or mineral spirit. Solvent mixtures which contain in particular more highly substituted aromatics, for example commercially available as solvent naphtha, Solvesso® (Exxon Chemicals, Houston, USA), Cypar® (Shell Chemicals, Eschborn, Germany), Cyclo Sol® (Shell Chemicals, Eschborn, Germany), Tolu Sol® (Shell Chemicals, Eschborn, Germany), Shellsol® (Shell Chemicals, Eschborn, Germany), are likewise suitable. Solvents which may be used are moreover carbonic acid esters, such as dimethyl carbonate, diethyl carbonate, 1,2-ethylene carbonate and 1,2-propylene carbonate; lactones, such as 1,3-propiolactone, isobutyrolactone, caprolactone, methylcaprolactone, propylene glycol diacetate, diethylene glycol dimethyl ether, dipropylene glycol dimethyl ether, diethylene glycol ethyl acetate, N-methylpyrrolidone and N-methylcaprolactam.

The isocyanate used in component β) is preferably an aliphatic, cycloaliphatic, araliphatic and/or aromatic compound, preferably a diisocyanate or triisocyanate, mixtures of these compounds also being possible. It is to be regarded as preferred here if it is hexamethylene 1,6-diisocyanate (HDI), 1-isocyanato-3,3,5-trimethyl-5-isocyanatomethylcyclohexane (IPDI), 2,4- and/or 2,6-toluene diisocyanate (TDI) and/or 4,4′-, 2,4′- and/or 2,2′-diphenylmethane diisocyanate (MDI), m-xylene diisocyanate (MXDI), m- or p-tetramethylxylene diisocyanate (m-TMXDI, p-TMXDI), 4,4′-dicyclohexylmethane diisocyanate (H12MDI), naphthalene 1,5-diisocyanate, cyclohexane 1,4-diisocyanate, hydrogenated xylylene diisocyanate (H6XDI), 1-methyl-2,4-diisocyanato-cyclohexane, tetramethoxybutane 1,4-diisocyanate, butane 1,4-diisocyanate, 1,6-diisocyanato-2,2,4-trimethylhexane, 1,6-diisocyanato-2,4,4-trimethylhexane, 1-isocyanato-1-methyl-4(3)-isocyanatomethylcyclohexane (IMCI) and 1,12-dodecane diisocyanate (C12DI).

The polyol and/or polyamine used in component α) preferably comprises polyetherpolyols, polyesterpolyols, polybutadienepolyols and polycarbonatepolyols, mixtures of these compounds also being possible. The polyols and/or polyamines preferably contain between 2 and 10, particularly preferably 2 or 3, hydroxyl groups and/or amino groups and have a weight average molecular weight between 32 and 20 000, particularly preferably between 90 and 18 000, g/mol. Suitable polyols are preferably the glassy solid/amorphous or crystalline polyhydroxy compounds which are liquid at room temperature. Difunctional polypropylene glycols may be mentioned as typical examples. Random copolymers and/or block copolymers of ethylene oxide and propylene oxide which have hydroxyl groups can also be used. Suitable polyetherpolyols are the polyethers known per se in polyurethane chemistry, such as the polyols prepared using starter molecules from styrene oxide, propylene oxide, butylene oxide, tetrahydrofuran or epichlorohydrin. Specifically, poly(oxytetramethylene)glycol (Poly-THF), 1,2-polybutylene glycol or mixtures thereof are also particularly suitable. Polypropylene oxide and polyethylene oxide and mixtures thereof are particularly suitable. A further copolymer type which can be used as the polyol component and has terminal hydroxyl groups is according to the general formula (preparable, for example, by means of “Controlled” High-Speed Anionic Polymerization according to Macromolecules 2004, 37, 4038-4043):

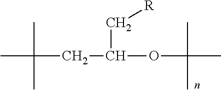

in which R is identical or different and is preferably represented by OMe, OiPr, Cl or Br.

Furthermore suitable as the polyol component are in particular the glassy amorphous or crystalline polyesterdiols or polyesterpolyols which are liquid at 25° C. and can be prepared by condensation of di- or tricarboxylic acids, such as adipic acid, sebacic acid, glutaric acid, azelaic acid, suberic acid, undecanedioic acid, dodecanedioic acid, 3,3-dimethylglutaric acid, terephthalic acid, isophthalic acid, hexahydrophthalic acid and/or dimeric fatty acid, with low molecular weight diols, triols or polyols, such as ethylene glycol, propylene glycol, diethylene glycol, triethylene glycol, dipropylene glycol, 1,4-butanediol, 1,6-hexanediol, 1,8-octanediol, 1,10-decanediol, 1,12-dodecanediol, dimeric fatty alcohol, glycerol, pentaerythritol and/or trimethylolpropane.

A further suitable group of polyols comprises the polyesters, for example based on caprolactone, which are also referred to as “polycaprolactones”. Further polyols which may be used are polycarbonate polyols and dimeric diols and polyols based on vegetable oils and their derivatives, such as castor oil and the derivatives thereof or epoxidized soybean oil. Also suitable are polycarbonates which have hydroxyl groups and are obtainable by reaction of carbonic acid derivatives, e.g. diphenyl carbonate, dimethyl carbonate or phosgene, with diols. For example, ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethylpentane-1,3-diol, dipropylene glycol, polypropylene glycols, dibutylene glycol, polybutylene glycols, bisphenol A, tetrabromobisphenol A, glycerol, trimethylolpropane, 1,2,6-hexanetriol, 1,2,4-butanetriol, trimethylolpropane, pentaerythritol, quinitol, mannitol, sorbitol, methylglycoside and 1,3,4,6-dianhydrohexitols are particularly suitable. Hydroxy-functional polybutadienes, which are commercially available, inter alia, under the trade name “Poly-bd®”, can also be used as polyols, as can the hydrogenated analogues thereof. Hydroxy-functional polysulphides, which are marketed under the trade name “Thiokol® NPS-282” and hydroxy-functional polysiloxanes are furthermore suitable.

In particular, hydrazine, hydrazine hydrate and substituted hydrazines, such as N-methylhydrazine, N,N′-dimethylhydrazine, acid hydrazides of adipic acid, methyl adipic acid, sebacic acid, hydracrylic acid, terephthalic acid, semicarbazidoalkylenehydrazides, such as 13-semicarbazidopropionic acid hydrazide, semicarbazido alkylene carbazine esters, such as, for example, 2-semicarbazidoethyl carbazine ester, and/or aminosemicarbazide compounds, such as 13-aminoethylsemicarbazidocarbonate, are suitable as polyamines which can be used according to the invention.

Polyamines, for example those which are marketed under the trade name Jeffamine® (these are polyetherpolyamines), are also suitable. Other suitable polyols and/or polyamines are the species known as so-called chain extenders, which react with excess isocyanate groups in the preparation of polyurethanes and polyureas, usually have a molecular weight (Mₙ) of less than 400 and are frequently present in the form of polyols, aminopolyols or aliphatic, cycloaliphatic or araliphatic polyamines.

Examples of suitable chain extenders are:
alkanediols, such as ethanediol, 1,2- and 1,3-propanediol, 1,4- and 2,3-butanediol, 1,5-pentanediol, 1,3-dimethylpropanediol, 1,6-hexanediol, neopentylglycol, cyclohexanedimethanol, 2-methyl-1,3-propanediol,
etherdiols, such as diethylene diglycol, triethylene glycol or hydroquinone dihydroxyethyl ether
hydroxybutyl hydroxycaproic acid ester, hydroxyhexyl hydroxybutyric acid ester, hydroxyethyl adipate and bishydroxyethyl terephthalate, and
polyamines, such as ethylenediamine, 1,2- and 1,3-diaminopropane, 1,4-diaminobutane, 1,6-diaminohexane, isomer mixture of 2,2,4- and 2,4,4-trimethylhexamethylenediamine, 2-methylpentamethylenediamine, diethylenetriamine, 1,3- and 1,4-xylylenediamine and 4,4-diaminodicyclohexylmethane

Finally it should be mentioned that the polyols and/or polyamines may contain double bonds, which can result, for example, from long-chain, aliphatic carboxylic acids or fatty alcohols. Functionalization with olefinic double bonds is also possible, for example, by the incorporation of vinylic or allylic groups. These may originate, for example, from unsaturated acids, such as maleic anhydride, acrylic acid or methacrylic acid and respective esters thereof.

It is particularly preferred in the context of the invention if the polyol and/or polyamine used in the component α) is polypropylenediol, polypropylenetriol, polypropylenepolyol, polyethylenediol, polyethylenetriol, polyethylenepolyol, polypropylenediamine, polypropylenetriamine, polypropylenepolyamine, poly-THF-diamine, polybutadienediol, polyesterdiol, polyestertriol, polyesterpolyol, polyesteretherdiol, polyesterethertriol, polyesteretherpolyol, particularly preferably polypropylenediol, polypropylenetriol, poly-THF-diol, polyhexanediolcarbamatediol, polycaprolactamdiol and polycaprolactamtriol. Mixtures of said compounds are furthermore possible.

Regarding the silylating agents preferably to be used according to the present invention, reference is made to the Patent Applications WO2006/088839 A2 and WO 2008/061651 A1 and the Patent EP 1 685171 B1, the content of which is hereby incorporated in the application.

Silylating agents which are further preferred for the present invention are in particular silanes of the general formula:

Y—R¹—Si(Me)ₙ(OR²)₃₋ₙ

in which Y is represented by —NCO, —NHR, —NH₂ or —SH,
R is represented by an alkyl group having 1 to 10 carbon atoms,
R¹ is represented by a divalent hydrocarbon unit having 1 to 10 carbon atoms,
Me is represented by methyl,
OR², independently of one another, is represented by an alkoxy group, in which
R² represents an alkyl group having 1 to 5 carbon atoms, and/or OR² represents a phenoxy group, a naphthyloxy group, a phenoxy group which is substituted at the ortho, meta- and/or para position by a C₁-C₂₀ alkyl, alkylaryl, alkoxy, phenyl, substituted phenyl, thioalkyl, nitro, halogen, nitrile, carboxyalkyl, carboxyamide, —NH₂ and/or NHR group, in which R represents a linear or branched C₁₀-C₅ alkyl group or phenyl.
n is represented by 0 to 3.

However, mixtures of at least two of said compounds can also be used as the silylating agent.

In a preferred embodiment, in particular alkoxysilanes containing amino groups or isocyanate groups are used. Suitable alkoxysilanes containing amino groups are in particular compounds which are selected from the group consisting of 3-aminopropyltrimethoxysilane, 3-aminopropyldimethoxymethylsilane, 3-amino-2-methylpropyltrimethoxysilane, aminobutyltrimethoxysilane, 4-aminobutyl-dimethoxymethylsilane, 4-amino-3-methylbutyltrimethoxysilane, 4-amino-3,3-dimethylbutyltrimethoxysilane, 4-amino-3,3-dimethylbutyldimethoxy-methylsilane, 2-aminoethyltrimethoxysilane, 2-aminoethyldimethoxy-methylsilane, aminomethyltrimethoxysilane, aminomethyldimethoxymethyl-silane, aminomethylmethoxydimethylsilane, N-methyl-3-aminopropyltrimethoxy-silane, N-ethyl-3-aminopropyltrimethoxysilane, N-butyl-3-aminopropyltri-methoxysilane, N-cyclohexyl-3-aminopropyltrimethoxysilane, N-phenyl-3-aminopropyltrimethoxysilane, N-methyl-3-amino-2-methylpropyltrimethoxy-silane, N-ethyl-3-amino-2-methylpropyltrimethoxysilane, N-ethyl-3-aminopropyl-dimethoxymethylsilane, N-phenyl-4-aminobutyltrimethoxysilane, N-phenyl-aminomethyldimethoxymethylsilane, N-cyclohexylaminomethyldimethoxy-methylsilane, N-methylaminomethyldimethoxymethylsilane, N-ethylamino-methyldimethoxymethylsilane, N-propylaminomethyldimethoxymethylsilane, N-butylaminomethyldimethoxymethylsilane, N-(2-aminoethyl)-3-aminopropyl-trimethoxysilane, 3-[2-(2-aminoethylamino)ethylamino]propyltrimethoxysilane, bis(trimethoxysilylpropyl)amine, and the analogues thereof having ethoxy or isopropoxy groups instead of the methoxy groups on the silicon.

Suitable alkoxysilanes containing isocyanate groups are in particular compounds which are selected from the group consisting of isocyanatopropyl-triethoxysilane, isocyanatopropyltrimethoxysilane, isocyanatopropylmethyl-diethoxysilane, isocyanatopropylmethyldimethoxysilane, isocyanatomethyl-trimethoxysilane, isocyanatomethyltriethoxysilane, isocyanatomethylmethyl-diethoxysilane, isocyanatomethylmethyldimethoxysilane, isocyanatomethyldimethylmethoxysilane or isocyanatomethyl-dimethylethoxysilane.

Finally, the present invention furthermore relates to silylated polyurethanes and/or polyureas which can be prepared by the process described above.

The products obtained, containing silylated polyurethanes/polyureas, can be used, for example, in adhesives and sealants. In a further embodiment of the present invention, a continuous process for the preparation of adhesives and sealants and continuous compounding can be linked to the process according to the invention.

The present invention is to be described below in more detail with reference to a working example.

### EXAMPLE

### Continuous Synthesis of Silylated Polyurethane Prepolymer Using Spinning-Disc Reactor and Static Mixer

The following example according to the invention was carried out using a spinning-disc reactor (rotating body A) which is in the form of a smooth disc having a diameter of 20 cm and consists of copper, the surface being chromium-plated. The disc is present on a vertical axis and is surrounded by a metallic housing which is cooled to 0° C. The disc is heated from the inside with a heat-transfer oil. Comparable reactors are also detailed in the documents WO00/48728, WO00/48729, WO00/48730, WO00/48731 and WO00/48732. Polypropylene glycol 4000 (PPG 4000) (e.g. Acclaim® Polyol 4200N, from Bayer AG), polypropylene glycol 8000 (PPG 8000) (e.g. Acclaim® Polyol 8200N, from Bayer AG), 0.1% of bismuth neodecanoate (from Aldrich) and 1-isocyanato-3,3,5-trimethyl-5-isocyanatomethylcyclohexane (IPDI, e.g. Vestanat® IPDI, from Evonik Industries GmbH) are pumped into a static mixer and mixed continuously there directly before metering on to the disc with the aid of gear pumps and, for the catalyst, by means of an HPLC pump while blanketing with nitrogen. Thereafter, the mixture is introduced centrally on to the rotating disc at a metering rate of 5 ml/s using a gear pump while blanketing with nitrogen. Said disc rotates at 900 rpm (rpm=revolutions per minute) and has a temperature of 200° C. The polyurethane formed leaves the disc (average residence time on the disc: 3-4 s) and is cooled on the reactor wall. It leaves the spinning-disc reactor at a temperature of 70° C. The NCO content can be determined by sampling and titration or by an online NCO measurement. The polyurethane obtained is passed continuously by means of a further gear pump into a static mixer, at the same time a stabilizer and the required amount of a trialkoxysilane containing amino groups being metered continuously in order to convert all NCO groups present with the amine into the urea (endcapping). After leaving the continuous mixing apparatus, the NCO content is monitored by IR spectroscopy or online by NIR measurement (0% residual NCO content). Required time for the preparation of 10 kg: about 0.6 h

| | | |
|---|---|---|
| NCO content of polyurethane before endcapping | 0.98% | by weight |
| Viscosity of silylated prepolymer¹ | 57 000 | mPa s |
| MW² | 106 700 | g/mol |
| PDI² | 3.0 | |
| Maximum MP² | 57 700 | g/mol |

¹according to DIN EN ISO 2555 EN
²average molecular weight (MW), polydispersity (PDI) and maximum of the molecular weight distribution (MP) determined by GPC (polystyrene standards, solvent THF)

### Physical Properties of Silylated Polyurethane Sealant Prepared Therefrom

| | Silylated polyurethane |
|---|---|
| | sealant |
| Tensile strength³/N/mm² | 2.66 |
| Elongation³/% | 129 |
| Force at 100% elongation³/N/mm² | 2.21 |
| Skin formation time/min | 22 |
| Hand sample | resilient |

³according to DIN 53504

1. Process for the preparation of silylated polyurethanes and/or polyureas, comprising:
a) application of a component β) containing isocyanate and of a component α) containing polyol and/or polyamine to at least one surface of body A, which surface rotates about an axis of rotation and has a temperature between 60 and 400° C. to form a reaction mixture, and reacting the component β) containing isocyanate and the component α) containing polyol and/or polyamine to form a reaction product; and,
b) reaction of the reaction product of β) isocyanate and α) polyol and/or polyamine with a silylating agent.

2. Process according to claim 1, wherein the silylating agent is applied to a surface of the body A, the application being carried out in a surface region on which the degree of reaction of β) isocyanate with α) polyol and/or polyamine is at least 75 mol %, if appropriate based on the component used in less than the stoichiometric amount.

3. Process according to claim 1, wherein the reaction product of β) isocyanate and α) polyol and/or polyamine is reacted with a silylating agent in a mixing apparatus after leaving the body A.

4. Process according to claim 1, wherein the reaction mixture is cooled after leaving the surface of the body A.

5. Process according to claim 1, wherein the process is operated continuously.

6. Process according to claim 1, wherein the reaction of the component α) with component β) is carried out with an excess of NCO groups.

7. Process according to claim 6, wherein alkoxysilanes containing amino groups are used as the silylating agent.

8. Process according to claim 1, wherein the reaction of the component α) with component β) is carried out with an excess of OH groups.

9. Process according to claim 8, wherein alkoxysilanes containing isocyanate groups are used as the silylating agent.

10. Process according to claim 1 wherein the surface of the body A extends to further rotating bodies so that, prior to cooling, the reaction mixture passes from the hot surface of the rotating body A to the hot surface of at least one further rotating body having a hot surface.

11. Process according to claim 1, wherein the rotating body A is present as a rotating disc to which the starting components α) and β) are applied individually and/or as a mixture with the aid of a metering system in the central region of the surface and, in order to cool the reaction mixture, a quench device in the form of a cooling wall surrounding the rotating disc is present, onto which quench device the reaction composition strikes after leaving the hot surface.

12. Process according to claim 1, wherein the amount of silylating agent which is introduced is controlled via a measurement by means of which the content of the groups reactive toward the silylating agent in the reaction mixture containing polyurethanes/polyureas is determined.

13. Process according to claim 1, wherein the isocyanate used in component β) is hexamethylene 1,6-diisocyanate (HDI), 1-isocyanato-3,3,5-trimethyl-5-isocyanatomethylcyclohexane (IPDI), 2,4- and/or 2,6-toluene diisocyanate (TDI), 4,4′-, 2,4′- and/or 2,2′-diphenylmethane diisocyanate (MDI), m-xylene diisocyanate (MXDI), m- or p-tetramethylxylene diisocyanate (m-TMXDI, p-TMXDI), 4,4′-dicyclohexylmethane diisocyanate (H12MDI), naphthalene 1,5-diisocyanate, cyclohexane 1,4-diisocyanate, hydrogenated xylylene diisocyanate (H6XDI), 1-methyl-2,4-diisocyanatocyclohexane, tetramethoxybutane 1,4-diisocyanate, butane 1,4-diisocyanate, hexane 1,6-diisocyanate (HDI), 1,6-diisocyanato-2,2,4-trimethylhexane, 1,6-diisocyanato-2,4,4-trimethyl hexane, 1-isocyanato-1-methyl-4(3)-isocyanatomethyl-cyclohexane (IMCI) and/or 1,12-dodecane diisocyanate (C12DI).

14. Process according to claim 1, wherein the polyol and/or polyamine used in component α) is polypropylenediol, polypropylenetriol, polypropylenepolyol, polyethylenediol, polyethylenetriol, polyethylenepolyol, polypropylenediamine, polypropylenetriamine, polypropylenepolyamine, poly-THF-diamine, polybutadienediol, polyesterdiol, polyestertriol, polyesterpolyol, polyesteretherdiol, polyesterethertriol, polyesteretherpolyol, polypropylenediol, polypropylenetriol, poly-THF-diol, polyhexanediolcarbamatediol, polycaprolactamdiol and/or polycaprolactamtriol.

15. Silylated polyurethanes and/or polyureas prepared by the process according to claim 1.
